(19) United States
(12) Patent Application Publication
(10) Pub. No.: US 2006/0068276 A1
(43) Pub. Date: Mar. 30, 2006

(54) Collector plate for rechargeable battery, electrode assembly, and rechargeable battery comprising the same

(75) Inventors: Seok-Yoon Yoo, Suwon-si (KR); Yong-Sam Kim, Suwon-si (KR)

Correspondence Address: H.C. PARK & ASSOCIATES, PLC, 8500 LEESBURG PIKE, SUITE 7500, VIENNA, VA, 22182, US

(73) Assignee: Samsung SDI Co., Ltd.

(21) Appl. No.: 11/228,263

(22) Filed: Sep. 19, 2005

(30) Foreign Application Priority Data
Sep. 24, 2004 (KR) 10-2004-0077053

(51) Int. Cl. H01M 2/26

(52) U.S. Cl. 429/161; 429/211

(57) ABSTRACT

A rechargeable battery comprises an electrode group including a positive electrode, a negative electrode with a separator interposed therebetween, a case in which the electrode group is inserted, a cap assembly that is coupled with the case to seal the case, and collector plates that are coupled with the electrode group to transfer an electric current to external terminals. In addition, the collector plates comprise protruding portions that protrude outward from a surface of each of the collector plates.

### CROSS REFERENCE TO RELATED APPLICATION

This application claims priority to and the benefit of Korean Patent Application No. 10-2004-0077053, filed in the Korean Intellectual Property Office on Sep. 24, 2004, the entire disclosure of which is incorporated herein by reference for all purposes as if fully set forth herein.

### BACKGROUND OF THE INVENTION

1. Field of the Invention

The present invention relates to a rechargeable battery comprising collector plates with an improved structure.

2. Description of the Background

Unlike a nonrechargeable battery, a rechargeable battery may be charged and discharged repeatedly. A low capacity battery comprising a single battery cell may be used as a power source for various portable electronic devices such as cellular phones, notebook computers, and camcorders. A high power battery in which numerous battery cells are connected to each other in a battery pack unit may be used as a power source for driving a motor of a hybrid electric vehicle (HEV), for example.

Depending on the external shape, rechargeable batteries may be classified into various shapes such as cylindrical, rectangular box, and a pouch shape. The rechargeable battery comprises an electrode group in a case and a cap assembly to cover the case. The electrode group includes a band-shaped positive electrode and negative electrode as well as a separator, which is an electrical insulator that is interposed between the positive electrode and the negative electrode. These components of the electrode assembly may be spirally wound together in the form of a jelly-roll and may be placed in the case.

Conductive lead terminals are coupled with the positive electrode and the negative electrode to collect an electric current that is generated by an electrochemical reaction at each of the electrodes. The conductive lead terminals transfer the electric current that is generated from the positive electrode and the negative electrode to a positive terminal and a negative terminal, respectively.

If the rechargeable battery has only one lead terminal that couples the electrode group with an external terminal in the cap assembly, a voltage generated from each part of the electrode assembly cannot be collected easily. This causes a potential difference between the region where the lead terminal is coupled to the electrode group and the other portions of the electrode group. This potential difference deteriorates the portion where the lead terminal is welded to the electrode group as the rechargeable battery is repeatedly discharged and recharged. This may cause the performance and lifespan of the rechargeable battery to diminish. This problem is more serious for batteries that drive a motor, which repeatedly discharges and recharges in a short time.

As a result, a multi-tab structure in which a plurality of lead terminals are coupled with the electrode group is suggested for high-performance rechargeable batteries. For example, U.S. Pat. No. 6,193,765 discloses a rechargeable battery that uses a disc-shaped plate as the lead terminal.

However, in the above-mentioned conventional rechargeable battery, due to a structural limitation of the above-mentioned collector plate, the collector plate may easily deform or may easily break during the assembly of the rechargeable battery. In particular, the collector plate includes a thin plate that may deform easily when the collector plate is welded to the electrode group. Further, since the collector plate cannot be grasped easily by ajig when the collector plate is welded, it is difficult to weld the collector plate at a precise position.

### SUMMARY OF THE INVENTION

The present invention provides a collector plate that resists deformation during assembly of a rechargeable battery, and an electrode assembly and a rechargeable battery comprising the same.

Additional features of the invention will be set forth in the description which follows, and in part will be apparent from the description, or may be learned by practice of the invention.

The present invention discloses a rechargeable battery comprising an electrode group comprising a positive electrode and a negative electrode with a separator interposed therebetween. The battery further comprises a case in which the electrode group is inserted and is a cap assembly comprising a collector plate that is coupled with the case. The collector plates have protruding portions that protrude outward from a surface of each of the collector plates. The collector plates are coupled with the electrode group to transfer an electric current to external terminals.

The present invention also discloses an electrode group comprising a positive electrode and a negative electrode that are spirally wound with a separator interposed therebetween. The electrode assembly further comprises uncoated regions that are formed along the longitudinal direction of the positive electrode and the negative electrode and have no active material coated thereon. In addition, the electrode assembly includes collector plates that comprise protruding portions that are coupled with the uncoated regions and protrude outward from a surface of each of the collector plates.

The present invention also discloses a collector plate of the rechargeable battery comprising a disc-shaped plate and a protruding portion that protrudes outward from a surface of the plate.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a cross-sectional view of a rechargeable battery according to an exemplary embodiment of the present invention.

FIG. 2 is a perspective view of a positive collector plate of the rechargeable battery according to the exemplary embodiment of the present invention.

FIG. 3 is a perspective view of a negative collector plate of the rechargeable battery according to the exemplary embodiment of the present invention.

FIG. 4 is a cross-sectional view that schematically shows how the positive collector plate of the rechargeable battery is grasped by a jig according to the exemplary embodiment of the present invention.

FIG. 5 is a cross-sectional view that schematically shows how the negative collector plate of the rechargeable battery is grasped by the jig according to the exemplary embodiment of the present invention.

### DESCRIPTION OF THE ILLUSTRATED EMBODIMENTS

The rechargeable battery of the present invention comprises a collector plate that may be grasped easily by a jig when the collector plate is coupled with the electrode assembly by the protruding portion, which protrudes outward from the collector plate. As a result, the deformation of the collector plate during coupling with the electrode assembly may be prevented and performance of the rechargeable battery may improve These properties make the rechargeable battery of the present invention suitable for use as the power source for high power motor-driven devices such as electric vehicles, hybrid electric vehicles, wireless vacuum cleaners, motorbikes, and motor scooters.

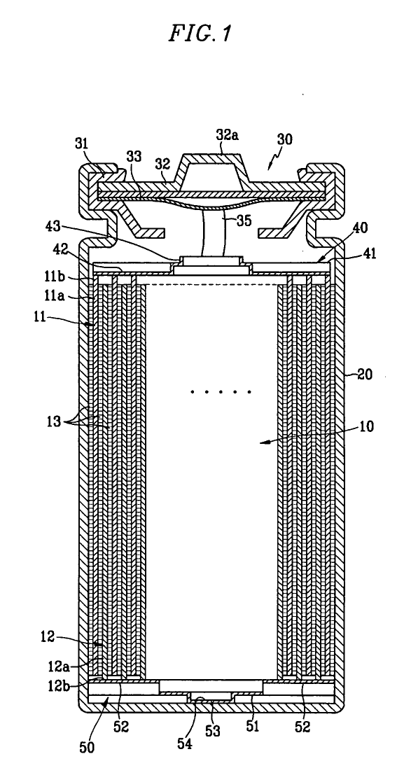

FIG. 1 is a cross-sectional view of a rechargeable battery according to an exemplary embodiment of the present invention.

As shown in FIG. 1, the rechargeable battery may include an electrode group 10 including a positive electrode 11 and a negative electrode 12 with a separator 13 interposed therebetween. The battery further comprises a case 20 with an opening at an end thereof to receive the electrode group 10 and an electrolyte. In addition, a cap assembly 30 is mounted at an upper part of the opening of the case 20 through a gasket 31 to seal the case 20.

The rechargeable battery further comprises a positive collector plate 40 that is coupled with the positive electrode 11 and a negative collector plate 50 that is coupled with the negative electrode 12.

In particular, the case 20 may comprise a conductive metal such as aluminum, an aluminum alloy, or nickel-plated steel, for example. The case may have a cylindrical-shape, for example, that defines an inner space for the electrode group 10. In the present embodiment, the case 20 acts as an external terminal for the negative electrode.

In the present embodiment, the rechargeable battery is cylindrical. However, the shape of the rechargeable battery is not limited thereto and may have other shapes such as rectangular box, and the like.

The electrode group 10 may have a layered structure such that the separator 13 is interposed between the positive electrode 11 and the negative electrode 12. Alternatively, the electrode group 10 may have a jelly-roll structure such that the positive electrode, the negative electrode, and the separator are sequentially stacked to be spirally wound. FIG. 1 shows a rechargeable battery in which a j elly-roll type electrode group 10 is provided in the cylindrical case 20.

The above-mentioned electrode group 10 forms an electrode assembly with the collector plates 40 and 50, which are coupled with the positive electrode 11 and negative electrode 12, respectively. In addition, the positive electrode 11 and the negative electrode 12 are coated with active materials in areas called a positive collector 11a and a negative collector 12a, respectively.

In order to form the electrode assembly, a negative uncoated region 12b, in which a negative active material is not coated is formed along the longitudinal direction of the negative electrode 12 at an edge of the negative collector 12a and is coupled with the negative collector plate 50. A positive uncoated region 11b, on which a positive active material is not coated, is formed along the longitudinal direction of the positive electrode 11 at an edge of the positive collector 11a and is coupled with the positive collector plate 40.

The cap assembly 30 is coupled with the case 20 to seal the case 20, and acts as the external terminal for the positive electrode in the present embodiment. The cap assembly 30 may include a cap plate 32 that has an external terminal 32a and a gasket 31 that insulates the cap plate 32 from the case 20. The cap assembly 30 may further comprise a vent plate 33 that breaks under a prescribed pressure and discharges gas to prevent explosion of the battery. The vent plate 33 is coupled with the positive collector plate 40 through a lead 35.

FIG. 2 is a perspective view of the positive collector plate 40 of the rechargeable battery according to the exemplary embodiment of the present invention.

As shown in FIG. 2, the positive collector plate 40 includes a disc-shaped plate 41, a hole 44 formed at the center of the plate 41, and a protruding portion 43. In particular, the protruding portion protrudes in an opposite direction to a surface that is coupled with the positive uncoated region 11b, from the edge of the hole 44.

In addition, one or more contacting portions 42 may be disposed radially around the protruding portion 43 and may protrude from the plate 41 toward the positive uncoated region 11b.

As shown in FIG. 2, in the present embodiment, four contacting portions 42 are disposed about the protruding portion 43 and are spaced at an angle of about 90°. The contacting portions 42 may be formed into a substantially slot-shape with the protruding portion 43 by embossing the collector plate 40.

There is no limitation on the height of the protruding portion 43 as long as it does not reach the cap assembly 30. In addition, the protruding portion 43 may be formed in various shapes besides cylindrical such as a polyhedron, for example.

The protruding portion 43 acts as a reinforcing member to strengthen the plate 41 of the positive collector plate 40.

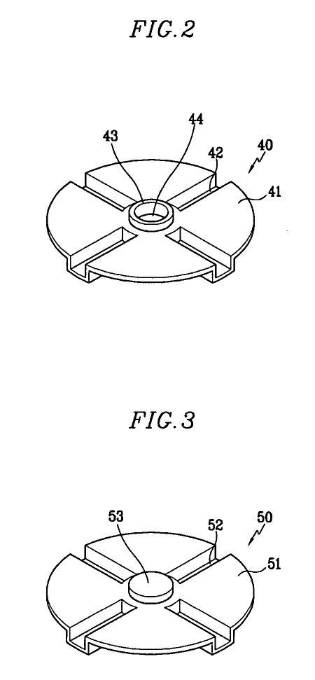

FIG. 3 is a perspective view of the negative collector plate according to an exemplary embodiment of the present invention.

As shown in FIG. 3, the negative collector plate 50 includes a disc-shaped plate 51 and a protruding portion 53 that protrudes in an opposite direction to a surface that is coupled with the negative uncoated region 12b. A recessed portion 54 with a predetermined depth is formed in the protruding portion 53 (see FIG. 1).

In addition, one or more contacting portions 52 may be disposed radially around the protruding portion 53 and protrude from the plate 51 toward the negative uncoated region 12b.

As described above, the protruding portion 53 may be formed with the contacting portion 52 by embossing the plate 51 of the collector plate. For example, four contacting portions 52 may be disposed around the protruding portion 53 to have a substantially cross-shape as shown in FIG. 3.

Herein, there is no limitation on the height of the protruding portion 53.

The protruding portion 53 of the negative collector plate 50 has a recessed portion. The negative collector plate 50 is coupled with the case 20 by laser-welding the recessed portion to a bottom surface of the case 20. The contacting portion 52, which protrudes in the opposite direction of the protruding portion 53, is coupled with the negative uncoated region 12b by laser-welding.

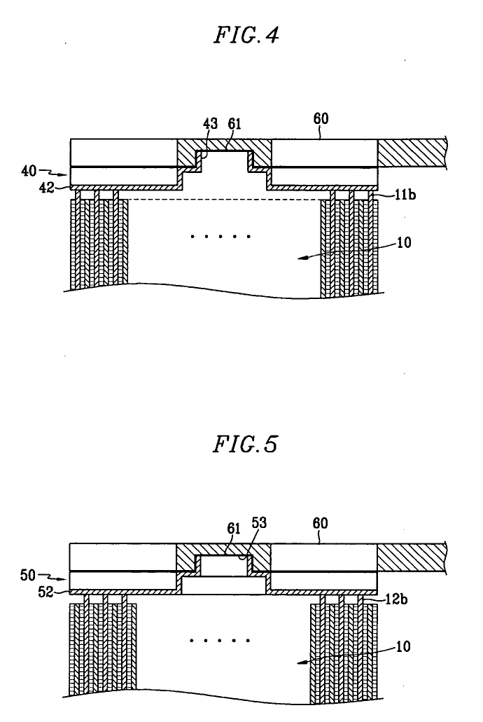

Hereinafter, operation of the rechargeable battery having the above-mentioned structure will be described with reference to FIG. 4 and FIG. 5.

The electrode group 10 forms an electrode assembly by coupling the positive collector plate 40 and the negative collector plate 50 to the uncoated regions 11b and 12b, respectively, which are formed at both ends of the electrode group 10.

The positive collector plate 40 may be coupled with the positive uncoated region 11b by laser-welding the contacting portion 42 to the positive uncoated region 11b of the electrode group 10.

As shown in FIG. 4, the positive collector plate 40 is grasped by a jig 60 that prevents movement of the positive collector plate 40 when it is coupled with the electrode group 10. In this case, the protruding portion 43 of the positive collector plate 40 is inserted into a recessed portion 61 of the jig 60 to easily grasp the positive collector plate 40 with the jig 60.

Similarly, the negative collector plate 50 may be coupled with the negative uncoated region 12b by the protruding portion 53. Thus, the negative collector plate 50 may be welded in a precise position, as shown in FIG. 5.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A battery, comprising:
an electrode group comprising a positive electrode and a negative electrode with a separator interposed therebetween;
a case in which the electrode group is inserted;
a cap assembly coupled with the case; and
a collector plate,
wherein the collector plate comprises a protruding portion that is coupled with the electrode group,
wherein the collector plate transfers an electric current to an external terminal, and
wherein the protruding portion protrudes outward from a surface of the collector plate.

2. The battery of claim 1,
wherein the collector plate is coupled with the positive electrode.

3. The battery of claim 2,
wherein the protruding portion protrudes from an edge of a hole formed on a part of the collector plate.

4. The battery of claim 3,
wherein the protruding portion protrudes in a direction opposite to a surface of the collector plate that is coupled with the electrode group.

5. The battery of claim 1,
wherein the collector plate is coupled with the negative electrode.

6. The battery of claim 5,
wherein a recessed portion is formed in the protruding portion.

7. The battery of claim 6,
wherein the protruding portion protrudes in a direction opposite to a surface of the collector plate that is coupled with the electrode group.

8. The battery of claim 1,
wherein the protruding portion is substantially circular.

9. The battery of claim 1,
wherein the battery is substantially cylindrical.

10. A motor-driven device, comprising:
the battery of claim 1.

11. An electrode assembly, comprising:
an electrode group comprising a positive electrode and a negative electrode with a separator interposed therebetween;
a positive uncoated region that is not coated with an active material and is formed along a longitudinal direction of the positive electrode;
a negative uncoated region that is not coated with an active material and is formed along a longitudinal direction of the negative electrode;
a positive collector plate; and
a negative collector plate,
wherein the positive collector plate is coupled with the positive uncoated region,
wherein the negative collector plate is coupled with the negative uncoated region, and
wherein the positive collector plate and the negative collector plate each have a protruding portion that protrudes outward from a surface of each of the collector plates, respectively.

12. The electrode assembly of claim 11,
wherein the protruding portion of the positive collector plate protrudes from an edge of a hole that is formed at a center of the positive collector plate, and
wherein the protruding portion of the positive collector plate is coupled with the positive uncoated region.

13. The electrode assembly of claim 11,
wherein the protruding portion of the negative collector plate protrudes from a center of the negative collector plate, is coupled with the negative uncoated region, and comprises a recessed portion.

14. A collector plate, comprising:
a disc-shaped plate; and
a protruding portion,
wherein the protruding portion protrudes outward from a surface of the disk-shaped plate.
